(19) United States
(12) Patent Application Publication
(10) Pub. No.: US 2022/0148548 A1
(43) Pub. Date: May 12, 2022

(54) DETECTION DEVICE, PERCUSSION INSTRUMENT, AND DETECTION METHOD

(71) Applicant: Roland Corporation, Shizuoka (JP)

(72) Inventor: Kiyoshi Yoshino, Hamamatsu, Shizuoka (JP)

(73) Assignee: Roland Corporation, Shizuoka (JP)

(21) Appl. No.: 17/433,239

(22) PCT Filed: Feb. 28, 2019
(86) PCT No.: PCT/JP2019/007951

§ 371 Date: Aug. 24, 2021

(51) Int. Cl. G10H 3/14; G01H 11/08; G10D 13/10; G10D 13/02

(52) U.S. Cl. CPC G10H 3/146; G10D 13/02; G10D 13/26; G01H 11/08

(57) ABSTRACT

The disclosure provides a detection device, a percussion instrument, and a detection method. The percussion instrument includes a head; a base that has at least a portion formed in a curved shape and that is in contact with the head in a direction in which a curvature of the curved shape is changed with a vibration of the head; and a film-shaped piezoelectric sensor disposed on the base.

### BACKGROUND

### Technical Field

The disclosure relates to a detection device, a percussion instrument, and a detection method, and more particularly to a detection device, a percussion instrument, and a detection method with which detection of vibrations other than a vibration to be detected can be prevented.

### Description of Related Art

A detection device that detects the sound of a musical instrument by using a piezo sensor is known. For example, Patent Document 1 discloses a technique in which a film-shaped piezoelectric sensor is supported in a curved shape by a support tool and a surface of the support tool opposite to the side that supports the piezoelectric sensor is attached to the vibrating surface of a stringed instrument to detect the resonance sound of the body of the stringed instrument.

### RELATED ART

### Patent Document

[Patent Document 1] Japanese Laid-Open No. 2018-077310 (for example, paragraphs 0015 and 0029 and FIGS. 2 and 4)

### SUMMARY

### Technical Problem

However, in the above-mentioned conventional technique, since the structure detects a vibration (resonance sound of the body) by air propagation, there is a problem that a vibration (sound) other than the vibration to be detected (resonance sound of the body) is detected.

The disclosure has been made to solve the above-mentioned problem and provides a detection device, a percussion instrument, and a detection method with which detection of vibrations other than a vibration to be detected can be prevented.

### Solution to the Problem

In view of the above, a detection device according to the disclosure includes: a base that is formed of a film-shaped material into a curved shape and that is in contact with a head of a percussion instrument in a direction in which a curvature of the curved shape is changed with a vibration of the head of the percussion instrument; and a film-shaped piezoelectric sensor disposed on the base.

A percussion instrument according to the disclosure includes: a head; a base that is formed of a film-shaped material into a curved shape and that is in contact with the head in a direction in which a curvature of the curved shape is changed with a vibration of the head; and a film-shaped piezoelectric sensor disposed on the base.

A detection method according to the disclosure includes: bringing a base that is formed of a film-shaped material into a curved shape in contact with a head of a percussion instrument in a direction in which a curvature of the curved shape is changed with a vibration of the head of the percussion instrument; and detecting a vibration of the head by a film-shaped piezoelectric sensor disposed on the base.

### BRIEF DESCRIPTION OF THE DRAWINGS

FIG. 1 is a front perspective view of the detection device and a drum according to the first embodiment.

In FIG. 2, (a) is a partially enlarged cross-sectional view of the detection device and the drum taken along the line IIa-IIa of FIG. 1, and (b) is a partially enlarged cross-sectional view of the detection device and the drum in the IIb portion of (a) of FIG. 2.

In FIG. 3, (a) and (b) are partially enlarged cross-sectional views of the detection device and the drum in the IIb portion of (a) of FIG. 2.

FIG. 4 is a graph showing the frequency characteristics of signals detected by the detection device by making the striking surface vibrate.

In FIG. 5, (a) is a front perspective view of the detection device according to the second embodiment, and (b) is a partially enlarged cross-sectional view of the detection device and a drum, and (c) is a side view of the drum viewed in the arrow Vc direction of (b) of FIG. 5.

In FIG. 6, (a) is a partially enlarged cross-sectional view of the detection device and a drum according to the third embodiment, and (b) is a partially enlarged cross-sectional view of the detection device and a drum according to the fourth embodiment.

### DESCRIPTION OF THE EMBODIMENTS

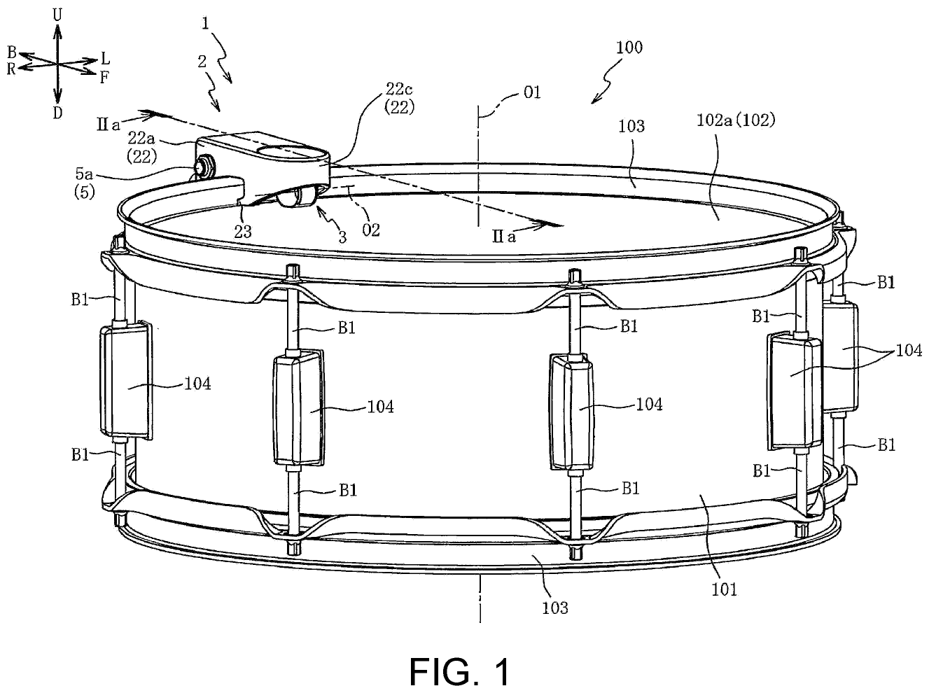

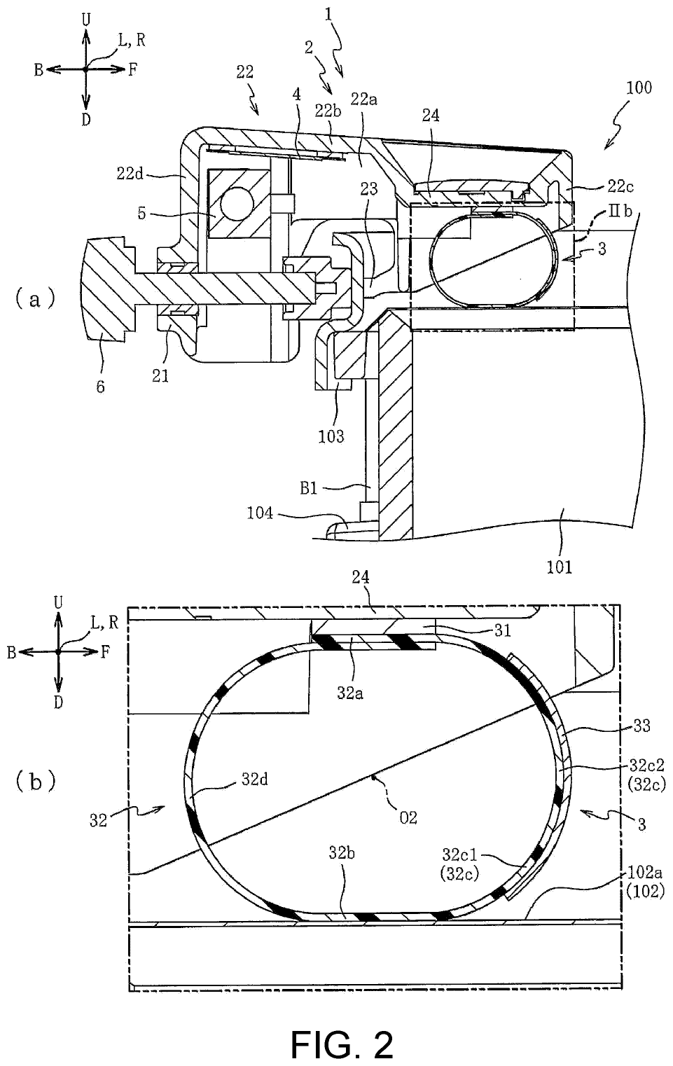

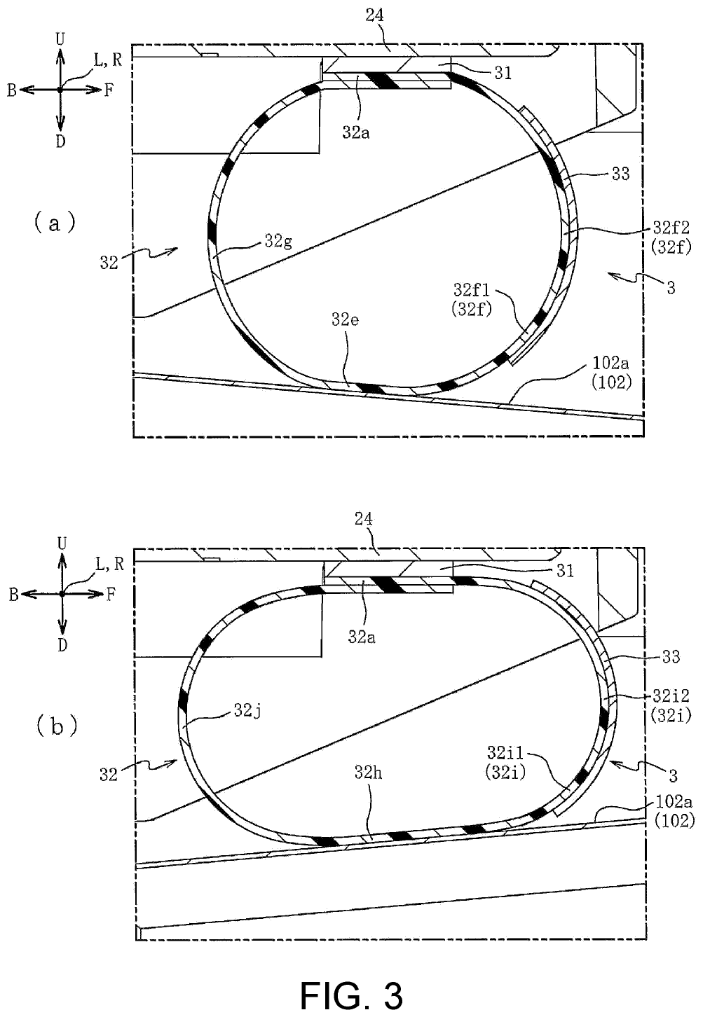

Hereinafter, exemplary embodiments will be described with reference to the accompanying drawings. First, the configuration of a detection device 1 according to a first embodiment will be described with reference to FIGS. 1 and 2. FIG. 1 is a front perspective view of the detection device 1 and a drum 100 according to the first embodiment. In FIG. 2, (a) is a partially enlarged cross-sectional view of the detection device 1 and the drum 100 taken along the line IIa-IIa of FIG. 1, and (b) is a partially enlarged cross-sectional view of the detection device 1 and the drum 100 in the IIb portion of (a) of FIG. 2.

Further, the arrows U-D, L-R, and F-B in FIG. 1 indicate the up-down direction, the left-right direction, and the front-back direction of the detection device 1, respectively, and the same applies to FIG. 2 and the following figures. Further, in a state where the detection device 1 is fixed to the drum 100, the up-down direction of the detection device 1 corresponds to an axis O1 direction of a shell 101 (striking surface 102a) of the drum 100, and the front-back direction of the detection device 1 corresponds to a radial direction of the shell 101 (striking surface 102a), respectively. Further, FIGS. 1 and 2 show a state (hereinafter referred to as a “stationary state”) in which the detection device 1 is fixed to the drum 100 and before the striking surface 102a is vibrated (displaced).

As shown in FIGS. 1 and 2, the drum 100 includes a shell 101 formed in an annular shape when viewed in the axis O1 direction (arrow U-D direction), a pair of heads 102 covering openings formed on two sides of the shell 101 in the axis O1 direction, a pair of hoops 103 for fixing the heads 102 to the shell 101, and fixing parts 104 attached to the outer peripheral surface of the shell 101.

Further, the drum 100 may be provided with the head 102 on only one side in the axis 01 direction (arrow U direction side). Further, the shell 101 may be formed by opening only one side in the axis O1 direction and being closed on the other side in the axis O1 direction (arrow D direction side). Further, although the drum 100 is configured as an acoustic drum, it may be configured as an electronic drum.

Tension is applied to the head 102 by the hoop 103 while the head 102 covers the opening formed in the shell 101, and surfaces of the pair of heads 102 opposite to facing surfaces of the heads 102 are configured as the striking surfaces 102a. Tension is applied to the heads 102 by tightening bolts B1 penetrating through holes of the hoops 103 to the fixing parts 104.

The detection device 1 is a device for detecting a vibration generated by hitting the striking surface 102a of the drum 100 with a stick or the like (not shown) and a vibration generated by hitting the hoop 103 with a stick or the like (hereinafter referred to as a “rim shot”) and outputting a signal (voltage) based on the vibration to the outside. The detection device 1 includes a main body member 2, a striking surface sensor 3 disposed on the main body member 2, a rim sensor 4, an output device 5, and a fixing bolt 6.

By tightening (loosening) the fixing bolt 6, the detection device 1 can be fixed to the drum 100 (hoop 103) (the detection device 1 can be removed from the drum 100). As a result, the detection device 1 can be used for a plurality of drums. Further, the detection device 1 can be attached to an acoustic drum, and the detection device 1 can be configured as a drum trigger.

The main body member 2 includes a fixing part 21 made of a resin material or a metal material and extending in the up-down direction (arrow U-D direction) and a sensor attachment part 22 extending from the upper end of the fixing part 21 toward the central side (arrow F direction side) of the shell 101 (striking surface 102a), and is formed in an L shape in a side view.

The fixing bolt 6 is disposed on the fixing part 21 along the front-back direction (arrow F-B direction), and the sensor attachment part 22 is connected to the fixing part 21 on the upper side (arrow U direction side) of the fixing bolt 6.

The sensor attachment part 22 includes a pair of side plates 22a facing each other in the left-right direction thereof (arrow L-R direction), an upper plate 22b connecting the upper ends of the pair of side plates 22a, a front plate 22c connecting the front ends of the pair of side plates 22a, and a back plate 22d connecting the back ends of the pair of side plates 22a.

The pair of side plates 22a are formed with legs 23 which protrude to the lower side (arrow D direction side) from the lower surface of the side plates 22a and bend toward the front end side of the fixing bolt 6 (arrow B direction side) (see FIG. 1 for the other leg 23 with respect to the leg 23 shown in FIG. 2). The detection device 1 is fixed to the drum 100 by clamping the hoop 103 between the pair of legs 23 and the fixing bolt 6.

The sensor attachment part 22 is disposed to extend in the front-back direction (arrow F-B direction) across a position (hereinafter referred to as the “tightening position”) where the hoop 103 is clamped and tightened by the fixing bolt 6 and the pair of legs 23. The striking surface sensor 3 is attached to the sensor attachment part 22 on the tip side of the tightening position (arrow F direction side), and the rim sensor 4 is attached to the back side of the tightening position (arrow B direction side). Therefore, in the stationary state, the striking surface sensor 3 is disposed on the central side of the striking surface 102a with respect to the tightening position.

An attachment surface 24 to which the striking surface sensor 3 is attached is formed on the striking surface 102a side of the upper plate 22b (arrow D direction side), and the attachment surface 24 is formed to protrude to the lower side (arrow D direction) from the lower surface of the upper plate 22b. As a result, the distance between the attachment surface 24 and the striking surface 102a can be reduced in the up-down direction (arrow U-D direction), and the size of the striking surface sensor 3 can be reduced.

The striking surface sensor 3 includes a holding member 32 and a piezoelectric element 33 held (attached) to the holding member 32, and the holding member 32 is adhered to the attachment surface 24 via a double-sided tape 31.

The holding member 32 is for deforming the piezoelectric element 33 according to the vibration of the striking surface 102a due to an impact, and is formed of a polyethylene terephthalate (PET) film having predetermined deformation characteristics. In the embodiment, the predetermined deformation characteristics are set so as to have an elastic recovery force that allows the holding member 32 to elastically deform along the shape of the striking surface 102a and follow the vibration of the striking surface 102a when the holding member 32 comes into contact with the striking surface 102a.

The holding member 32 is a member formed in an annular shape by bending a sheet-shaped PET film having a rectangular shape in a plan view and superimposing two ends on top of each other, and is disposed in a posture in which an axis O2 direction of the annulus is aligned with the left-right direction of the detection device 1 (arrow L-R direction). The holding member 32 is formed so that the thickness dimension and the width dimension (dimension in the axis O2 direction) are constant over the entire circumference. Further, the holding member 32 may be formed in an annular shape by cutting a material formed into a tubular shape by pull-out molding in a plane orthogonal to the pull-out direction (axis O2 direction).

When the holding member 32 is adhered to the double-sided tape 31, a flat adhesive part 32a is formed on the holding member 32 along the shape of the double-sided tape 31. The adhesive part 32a is formed on the upper side of the holding member 32 (arrow U direction side).

Here, if the sheet-shaped PET film is curved in a semicircular shape to form the holding member, it is necessary to bond the holding member at two places, one end and the other end, to the attachment surface 24. On the other hand, since the holding member 32 is formed in an annular shape, the bonding place to the attachment surface 24 can be one place. In this way, the structure of the detection device 1 can be simplified.

Although the adhesive part 32a is formed flat on the holding member 32, the portion excluding the adhesive part 32a is formed to be curved. Further, the holding member 32 is formed in an endless shape. Therefore, in the embodiment, the holding member 32 in the state before the detection device 1 is fixed to the drum 100 is described as an annular shape.

Here, a method of fixing the detection device 1 to the drum 100 will be described.

The detection device 1 is disposed at a position where the distance between the striking surface 102a and the attachment surface 24 is smaller than the diameter of the holding member 32 in the up-down direction (arrow F-B direction), and the fixing bolt 6 is tightened. As a result, the holding member 32 can be brought into contact with the striking surface 102a in the stationary state.

Further, it is preferable to dispose the detection device 1 at a position where the distance between the striking surface 102a and the attachment surface 24 is smaller than the diameter of the holding member 32 even in a state where the striking surface 102a is most displaced to the lower side (arrow D direction side) from the stationary state (hereinafter referred to as the “downward displacement state”). As a result, the holding member 32 can be brought into contact with the striking surface 102a even in a state where the striking surface 102a is vibrating.

In the stationary state, a portion of the holding member 32 comes into contact with the striking surface 102a, whereby the portion excluding the adhesive part 32a is deformed. In the deformed portion of the holding member 32, the portion formed flat along the striking surface 102a is defined as a contact part 32b. The contact part 32b is formed on the lower side of the holding member 32 (arrow D direction side).

Further, among portions connecting the adhesive part 32a and the contact part 32b of the holding member 32, the portion on the front side (arrow F direction side) is defined as a front part 32c, and the portion on the back side (arrow B direction side) is defined as a back part 32d, respectively.

As will be described later, when the holding member 32 is deformed by the vibration of the striking surface 102a, for the contact part 32b, the front part 32c and the back part 32d of the holding member 32, the ratio of the formation range of each part (the contact part, the front part and the back part) to the entire holding member 32 and the curvature of each part change (see FIG. 3). Therefore, each part of the holding member 32 before and after the vibration (displacement) of the striking surface 102a is distinguished by being denoted a different reference numeral.

By elastically deforming the holding member 32 in advance in the stationary state, in a state where the striking surface 102a vibrates (displaces) (to be described later), it is possible to easily follow the deformation of the holding member 32 to the vibration (displacement) of the striking surface 102a.

Further, the holding member 32 is disposed in a posture in which the axis O2 direction of the holding member 32 is orthogonal to the vibration direction of the striking surface 102a (axis O1 direction, arrow U-D direction), and the front part 32c and the back part 32d are formed in a curved shape. As a result, the front part 32c and the back part 32d can be easily deformed according to the vibration (displacement) of the striking surface 102a as compared with the case where the front part 32c and the back part 32d are formed in a linear shape. Further, the front part 32c and the back part 32d can easily follow the vibration (displacement) of the striking surface 102a as compared with the case where the front part 32c and the back part 32d are formed by bending.

Further, since the adhesive part 32a and the contact part 32b are formed on the upper side (arrow U direction side) and the lower side (arrow D direction side) of the holding member 32, respectively, and are disposed to face the vibration direction of the striking surface 102a (axis O1 direction, arrow U-D direction), it is possible to set the elastic recovery force generated in the holding member 32 in the direction in which the adhesive part 32a is pressed against the double-sided tape 31, and it is possible to prevent a tensile force or a shearing force from being generated between the adhesive part 32a and the double-sided tape 31 when the striking surface 102a vibrates. Therefore, it is possible to prevent the holding member 32 from falling off from the sensor attachment part 22.

In the stationary state, the disposition of the holding member 32 in the radial direction of the drum 100 is at a position where the axis O2 of the holding member 32 is separated from the inner peripheral surface of the hoop 103 to the front side (arrow F direction) by a predetermined distance. In the embodiment, the predetermined distance is set to the outer diameter dimension of the holding member 32.

The predetermined distance is a distance at which the back part 32d and the hoop 103 are not in contact with each other even when the back part 32d of the holding member 32 is deformed to the maximum extent and the back part 32d is closest to the hoop 103, and is preferably set in the range of 0.5 to 1.5 times the outer diameter dimension of the holding member 32. In this way, it possible to prevent the back part 32d from coming into contact with the hoop 103. Further, since the holding member 32 is brought into contact with the striking surface 102a while avoiding the central side of the striking surface 102a, the area where a performer hits with a stick or the like (not shown) can be increased.

The piezoelectric element 33 is for detecting the vibration of the striking surface 102a based on the deformation of the holding member 32, and is formed by coating two sides of a film-shaped piezoelectric body with a metal material such as a nickel-copper alloy or silver.

Specifically, the piezoelectric element 33 is configured by FDT1-052K manufactured by Tokyo Sensor Co., Ltd. Further, in the embodiment, the film-shaped piezoelectric body, the coating, and a protective member are shown as an integral member, and the illustration of wiring and the like is omitted. Further, in FIGS. 1 and 2, in order to facilitate understanding, the thickness dimension with respect to the longitudinal dimension of the piezoelectric element 33 is schematically shown to be larger than the actual thickness dimension, and since the same applies to FIG. 3 and the following figures, the description thereof will be omitted.

The piezoelectric element 33 is entirely adhered to the outer peripheral surface of the front part 32c of the holding member 32 in a posture in which the longitudinal direction of the piezoelectric element 33 is aligned with the circumferential direction of the holding member 32. Therefore, the piezoelectric element 33 is curved and adhered along the shape of the front part 32c, and is deformed according to the deformation of the holding member 32 (front part 32c).

Further, the width dimension of the holding member 32 (dimension in the axis O2 direction) and the width dimension of the double-sided tape 31 (dimension in the arrow L-R direction) are formed larger than the dimension of the piezoelectric element 33 in the lateral direction (arrow L-R direction).

Here, the piezoelectric element 33 will be described. The piezoelectric element 33 generates a voltage (outputs a signal) according to the expansion and contraction amount, particularly the expansion and contraction amount in the longitudinal direction. If the piezoelectric element 33 is deformed into a curved shape and the curvature of the piezoelectric element 33 is changed from the state of being deformed into the curved shape, while the outer peripheral surface of the piezoelectric element 33 is expanded, the inner peripheral surface of the piezoelectric element 33 is contracted. As a result, the expansion and contraction of the inner peripheral surface and the outer peripheral surface of the piezoelectric element 33 cancel each other out, and the generated voltage becomes smaller.

On the other hand, in the embodiment, since the piezoelectric element 33 is adhered to the outer peripheral surface of the holding member 32 (front part 32c), the inner peripheral surface and the outer peripheral surface of the piezoelectric element 33 expand (contract) according to the change of the curvature of the holding member 32, that is, the expansion (contraction) of the outer peripheral surface of the holding member 32. In other words, by deforming the piezoelectric element 33 via the holding member 32, the entire piezoelectric element 33 (inner peripheral surface and outer peripheral surface) can be deformed in the same mode (expansion or contraction).

As a result, a larger voltage can be generated in the piezoelectric element 33 as compared with the case where the piezoelectric element 33 is deformed into a curved shape and the curvature of the piezoelectric element 33 is changed from the state of being deformed into the curved shape.

As the curvature of the holding member 32 increases, the expansion (contraction) of the outer peripheral surface of the holding member 32 with respect to the deformation of the holding member 32 increases. As a result, the voltage generated in the piezoelectric element 33 increases. In addition, since the holding member 32 is disposed in contact with the striking surface 102a, by increasing the curvature of the holding member 32 or by increasing the width dimension (dimension in the axis O2 direction) or thickness dimension of the holding member 32, the resistance of the holding member 32 to the vibration of the striking surface 102a increases.

Therefore, it is necessary to determine the curvature, width dimension, or thickness dimension of the holding member 32 in consideration of the balance between the magnitude of the voltage generated in the piezoelectric element 33 and the magnitude of the resistance to the vibration of the striking surface 102a. Further, it is also necessary to consider the followability of the holding member 32 to the vibration (displacement) of the striking surface 102a (difficulty of separating the holding member 32 from the striking surface 102a). In consideration of these, in the embodiment, the thickness dimension of the holding member 32 is set to 250 μm.

Further, in the front part 32c, the portion to which the piezoelectric element 33 is attached is defined as an attachment part 32c1. The attachment part 32c1 includes a front protrusion 32c2 protruding to the most front side of the front part 32c (arrow F direction side), and is formed to extend to both sides of the front protrusion 32c2 in the up-down direction (arrow U-D direction).

Further, the upper end and the lower end of the piezoelectric element 33 (attachment part 32c1) are disposed at a predetermined distance in the up-down direction (arrow U-D direction) from the lower end (not shown) of the holding member 32 in the state before the attachment surface 24 of the sensor attachment part 22 and the detection device 1 are fixed to the drum 100. In the embodiment, the predetermined distance is set to 1/10 of the outer diameter dimension of the holding member 32. Further, the predetermined distance is a distance at which the upper end and the lower end of the piezoelectric element 33 are not in contact with the attachment surface 24 of the sensor attachment part 22 and the striking surface 102a even when the holding member 32 is deformed to the maximum extent and the upper end and the lower end of the piezoelectric element 33 are closest to the attachment surface 24 of the sensor attachment part 22 and the striking surface 102a, and is preferably set in the range of 1/20 to ⅕ of the outer diameter dimension of the holding member 32.

Wiring (not shown) connected to the output device 5 is formed on the upper side of the piezoelectric element 33 (arrow U direction side), and a portion of the wiring is fixed to the attachment surface 24 of the sensor attachment part 22. The wiring passes between the pair of side plates 22a and is connected to the output device 5. As a result, it is possible to prevent the wiring from being cut.

The rim sensor 4 is for detecting the vibration generated by a rim shot, is configured by a piezoelectric element, and is attached to the lower surface of the upper plate 22b via a cushioning material.

The output device 5 is for outputting a signal (generated voltage) detected by the striking surface sensor 3 or the rim sensor 4 to the outside, and is electrically connected to the striking surface sensor 3 and the rim sensor 4. A signal (voltage) is output to the outside via a terminal 5a provided on the output device 5.

Next, a method of detecting the vibration of the striking surface 102a by the piezoelectric element 33 will be described with reference to FIG. 3. In FIG. 3, (a) and (b) are partially enlarged cross-sectional views of the detection device 1 and the drum 100 in the IIb portion of (a) of FIG. 2. Further, (a) of FIG. 3 shows the downward displacement state, and (b) of FIG. 3 shows a state in which the striking surface 102a is most displaced to the upper side (arrow U direction side) (hereinafter referred to as the “upward displacement state”) from the stationary state. Further, in FIG. 3, to facilitate understanding, the amplitude of the striking surface 102a is schematically shown to be larger than the actual amplitude.

As shown in (a) of FIG. 3, in the downward displacement state, a contact part 32e is formed smaller than the contact part 32b in the stationary state, and a front part 32f and a back part 32g are formed to have a smaller curvature than the front part 32c and the back part 32d in the stationary state (see (b) of FIG. 2).

As described above, since in the stationary state, the holding member 32 comes into contact with the striking surface 102a in a state of being elastically deformed in advance, it is possible to easily follow the deformation of the holding member 32 to the vibration (displacement) of the striking surface 102a by utilizing the elastic recovery force of the holding member 32. Further, by utilizing the deformation of the holding member 32 due to the elastic recovery, it is possible to easily maintain the contact between the striking surface 102a and the holding member 32 even in the downward displacement state. That is, it is possible to prevent the contact between the striking surface 102a and the holding member 32 from being interrupted.

Here, the main vibration of the striking surface 102a due to the impact is such that the displacement in the up-down direction (arrow U-D direction) increases toward the central side of the striking surface 102a with the contact portion (outer edge of the striking surface 102a) between the shell 101 and the head 102 as a reference point.

As described above, the disposition of the holding member 32 in the radial direction of the drum 100 is disposed at a position where the axis O2 of the holding member 32 is separated from the inner peripheral surface of the hoop 103 to the front side (arrow F direction) by a predetermined distance (outer diameter dimension of the holding member 32) (see (a) of FIG. 2). Therefore, the change rate of the curvature from the front part 32c to the front part 32f due to the displacement from the stationary state to the downward displacement state is larger than the change rate of the curvature from the back part 32d to the back part 32g. In other words, the change rate of the curvature from the front part 32c in the stationary state to the front part 32f in the downward displacement state is larger than the change rate of the curvature from the back part 32d in the stationary state to the back part 32g in the downward displacement state.

Further, similarly, the change rate of the curvature from the front part 32c to a front part 32i due to the displacement from the stationary state to the upward displacement state is larger than the change rate of the curvature from the back part 32d to a back part 32j (see (b) of FIG. 3).

As a result, by attaching the piezoelectric element 33 to the front side (front parts 32c, 32f and 32i) of the holding member 32 (where the attachment parts 32c1, 32f1 and 32i1 are formed), compared with the case of attaching the piezoelectric element 33 to the back side (back parts 32d, 32g and 32j) of the holding member 32, the difference in the amount of deformation (change rate of the curvature) of the piezoelectric element 33 due to the displacement from the stationary state to the downward displacement state (upward displacement state) can be increased, and the vibration of the striking surface 102a due to the impact can be easily detected.

Further, the holding member 32 in the radial direction of the drum 100 is disposed at a position where the axis O2 of the holding member 32 is separated from the inner peripheral surface of the hoop 103 to the front side by a predetermined distance (outer diameter dimension of the holding member 32) (see (a) of FIG. 2). Further, a portion of the holding member 32 (contact part 32b) is disposed in contact with the striking surface 102a. Therefore, when the outer diameter of the holding member 32 is formed to be sufficiently smaller than the outer diameter of the striking surface 102a, it can be considered that the holding member 32 comes into contact with the vicinity of the periphery of the striking surface 102a. In this case, vibrations containing a large amount of high frequency are detected among the vibrations of the striking surface 102a as compared with a case where the holding member 32 comes into contact with the vicinity of the center of the striking surface 102a. However, the holding member 32 may come into contact with the vicinity of the center of the striking surface 102a. In this case, vibrations containing a large amount of medium and low frequencies are detected among the vibrations of the striking surface 102a.

As shown in (b) of FIG. 3, in the upward displacement state, a contact part 32h is formed larger than the contact part 32b in the stationary state, and the front part 32i and the back part 32j are formed to have a larger curvature than the front part 32c and the back part 32d in the stationary state (see (b) of FIG. 2).

In the upward displacement state, a portion of the back part 32j protruding to the rearmost side (arrow B direction side) is displaced closer to the back side than a portion of the back part 32d protruding to the rearmost side in the stationary state.

As described above, in the stationary state, the holding member 32 is disposed at a distance such that even when the back part 32d of the holding member 32 is deformed to the maximum extent (changed from the back part 32d to the back part 32j) and the back part 32j is closest to the hoop 103, the back part 32j and the hoop 103 are not in contact with each other. As a result, it is possible to prevent the back part 32j from coming into contact with the hoop 103 even in the upward displacement state.

Further, as described above, the upper and lower ends of the piezoelectric element 33 (attachment part 32c1) are disposed at a predetermined distance (in the embodiment, 1/10 of the outer diameter dimension of the holding member 32) from the lower end (not shown) of the holding member 32 in the state before the attachment surface 24 of the sensor attachment part 22 and the detection device 1 are fixed to the drum 100. As a result, it is possible to prevent the attachment surface 24 or the striking surface 102a from coming into contact with the piezoelectric element 33 even in the upward displacement state.

As shown in (a) and (b) of FIG. 3, since the holding member 32 is deformed according to the vibration of the head 102 (striking surface 102a) (by a deforming force applied from the head 102), it is possible to increase the rigidity of the holding member 32. That is, since the vibration of the head 102 has stronger energy than the vibration propagated by air such as the performance sound of another musical instrument, by forming the holding member 32 with rigidity (deformation characteristics) that does not deform due to the vibration propagated by air, it is possible to prevent the holding member 32 from being deformed by the vibration propagated by air while ensuring the deformation of the holding member 32 due to the vibration of the head 102. As a result, it is possible to prevent detection of a vibration (vibration propagated by air) other than the vibration of the head 102.

Further, when the holding member 32 is deformed according to the vibration of the striking surface 102a, the holding member 32 has a large change rate of the curvature in the front protrusions 32f2 and 32i2 of the front parts 32f and 32i. Since the piezoelectric element 33 is attached to both sides of the front protrusion 32c2 in the up-down direction (arrow U-D direction) as well as to the front protrusion 32c2 (where the attachment part 32c1 is formed) (see (b) of FIG. 2), the change rate of the curvature of the piezoelectric element 33 before and after the vibration of the striking surface 102a can be increased, and the vibration of the striking surface 102a due to the impact can be easily detected.

Here, in order to deform the piezoelectric element 33 according to the vibration of the striking surface 102a due to the impact, it is conceivable to dispose a cushioning material configured by a columnar or cylindrical sponge, instead of the polyethylene terephthalate (PET) film, between the striking surface 102a and the piezoelectric element 33 to replace the holding member 32. However, in this case, in order to maintain the shape of the cushioning material, the cushioning material needs to have a predetermined thickness. As a result, the damping of the vibration of the striking surface 102a may be increased by the cushioning material, and the minute vibration of the striking surface 102a may not be transmitted to the piezoelectric element 33.

On the other hand, in the embodiment, the holding member 32 is formed of a polyethylene terephthalate (PET) film and can have a smaller damping than the cushioning material configured by a sponge. Therefore, as compared with the case where the cushioning material is provided, it is possible to easily detect the minute vibration of the striking surface 102a due to the impact. As a result, the vibration can be detected even when the vibration generated by the impact on the striking surface 102a is damped and becomes a minute vibration, and the reverberation peculiar to the acoustic drum can be easily detected.

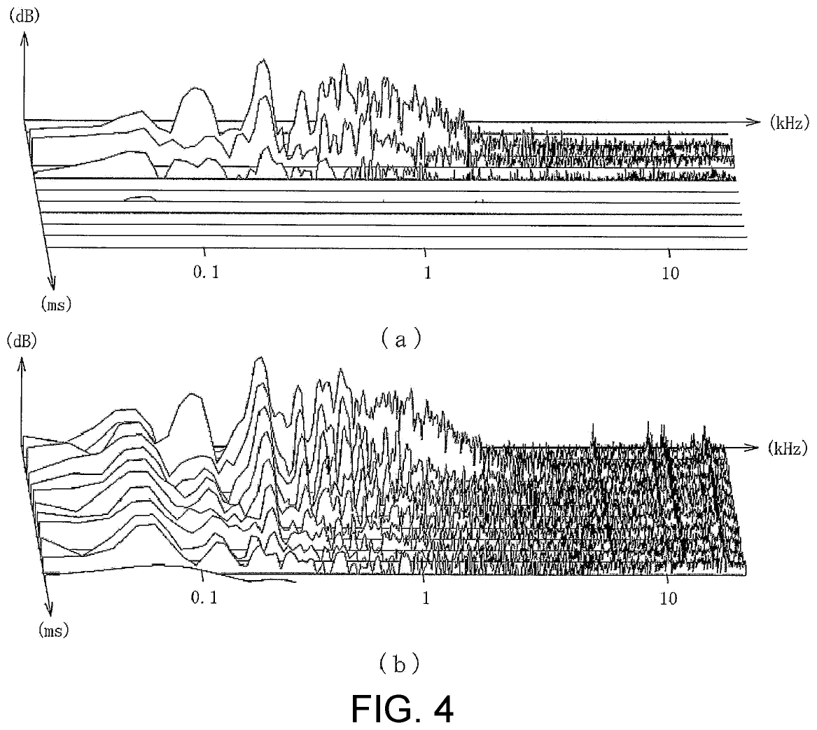

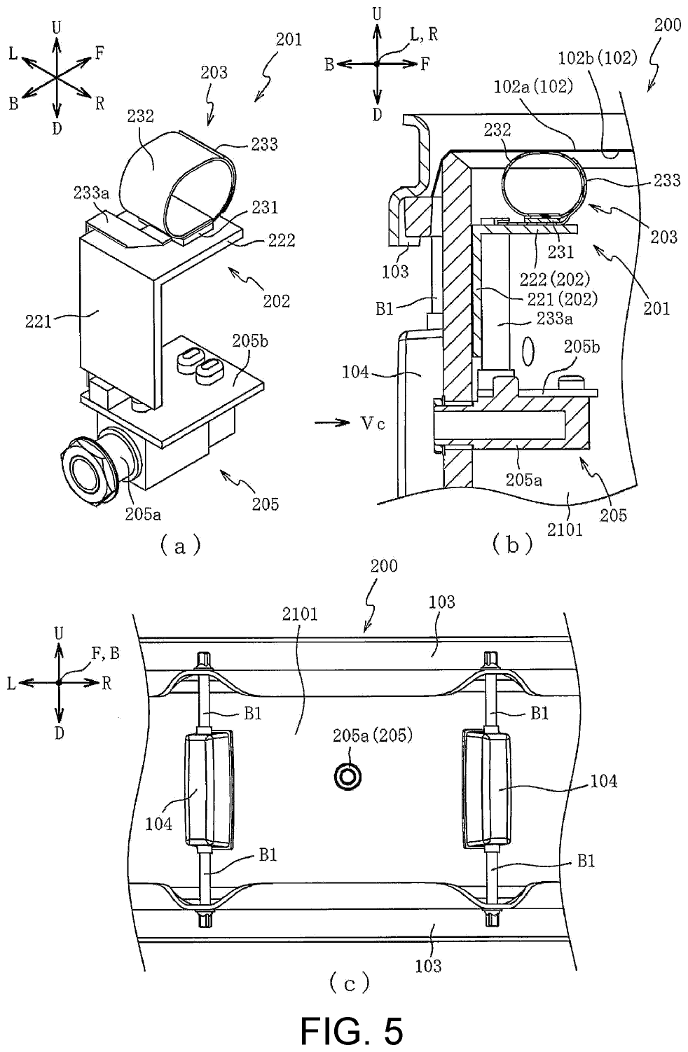

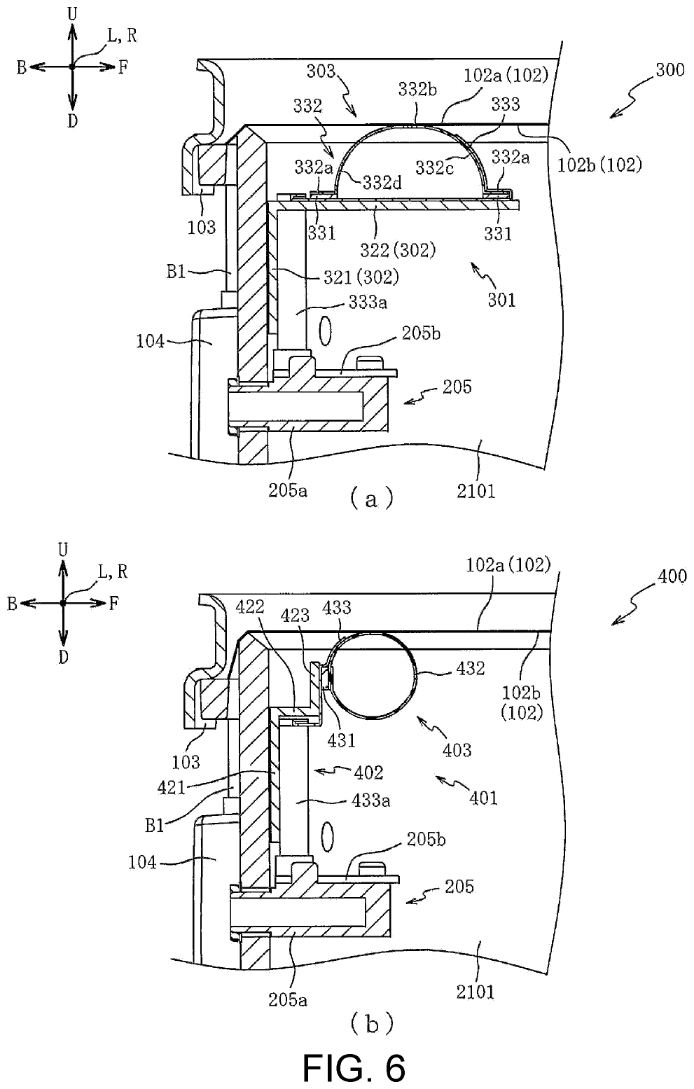

FIG. 4 shows the temporal change of the frequency characteristics of signals detected by making the striking surface 102a vibrate. The horizontal axis of FIG. 4 is the frequency (kHz), and the vertical axis of FIG. 4 is the magnitude of the signal level (dB), and FIG. 4 shows the frequency characteristics of the signals detected at predetermined time intervals (500 ms in the embodiment). Further, the horizontal axis of FIG. 4 is expressed logarithmically. Further, it indicates the elapse of time since the striking surface 102a was vibrated toward the front side of the paper with respect to the back side of the paper.

Further, (a) of FIG. 4 shows the frequency characteristics of the signals detected by a detection device (hereinafter referred to as the “conventional detection device”) having a structure in which a cushioning material configured by a sponge is clamped between a piezoelectric sensor, in which a ceramic piezo element is attached to a brass disk, and the striking surface 102a, and (b) of FIG. 4 shows the frequency characteristics of the signals detected by the detection device 1 in the embodiment. In addition, (a) and (b) of FIG. 4 respectively show the frequency characteristics of the signals detected when the conventional detection device and the detection device 1 are disposed at the same position on the striking surface 102a and the same position of the striking surface 102a is hit with a force of the same magnitude.

As shown in (a) and (b) of FIG. 4, the detection device 1 has a higher signal level at, for example, the vicinity of 0.08 kHz and the vicinity of 10 kHz than the conventional detection device. As described above, since the detection device 1 can detect the vibration of the striking surface 102a in the low frequency region and the high frequency region as compared with the conventional detection device, the vibration of the striking surface 102a can be detected more faithfully.

Further, in the conventional detection device, the vibration of the striking surface 102a converges after about 2000 ms have elapsed since the striking surface 102a was vibrated (the signal is detected), whereas in the detection device 1, the striking surface 102a vibrates even after about 4500 ms have elapsed since the striking surface 102a was vibrated. In this way, when the detection device 1 is brought into contact with the striking surface 102a as compared with the conventional detection device, the striking surface 102a vibrates even after a certain period of time has elapsed since the striking surface 102a was vibrated, and it can be seen that the damping of the vibration of the striking surface 102a by the detection device 1 is small.

That is, since the detection device 1 is unlikely to interfere with the vibration of the striking surface 102a as compared with the conventional detection device, the detection device 1 can more faithfully detect the original vibration of the striking surface 102a (vibration of the striking surface 102a when the detection device 1 (holding member 32) is not in contact with the striking surface 102a).

Next, a detection device 201 according to a second embodiment will be described with reference to FIG. 5. Further, the same parts as those in the first embodiment described above are denoted by the same reference numerals, and the description thereof will be omitted.

In FIG. 5, (a) is a front perspective view of the detection device 201 according to the second embodiment, and (b) is a partially enlarged cross-sectional view of the detection device 201 and a drum 200, and (c) is a side view of the drum 200 viewed in the arrow Vc direction of (b) of FIG. 5. Further, (b) of FIG. 5 corresponds to the cross section taken along the line IIa-IIa of FIG. 1.

As shown in (a) to (c) of FIG. 5, the detection device 201 according to the second embodiment includes an attachment member 202, a striking surface sensor 203 attached to the attachment member 202, and an output device 205 disposed on the lower side (arrow D direction) of the attachment member 202. The detection device 201 is fixed to the drum 200 by tightening with a bolt (not shown) or adhering the attachment member 202 to the inner peripheral surface of a shell 2101.

The attachment member 202 includes a fixing part 221 made of a resin material or a metal material and extending along the axis O1 direction of the shell 2101 (arrow U-D direction) (see FIG. 1) and a sensor attachment part 222 extending from the upper end of the fixing part 221 toward the central side (arrow F direction side) of the shell 2101, and is formed in an L shape in a cross-sectional view. The fixing part 221 is fixed to the inner peripheral surface of the shell 2101, and the striking surface sensor 203 is attached to the upper surface of the sensor attachment part 222.

The striking surface sensor 203 includes a holding member 232 and a piezoelectric element 233 held (attached) to the holding member 232, and the holding member 232 is adhered to the sensor attachment part 222 via a double-sided tape 231.

The holding member 232 is formed to be the same as the holding member 32 in the first embodiment except that the outer diameter of the holding member 232 is different from the outer diameter of the holding member 32. That is, the holding member 232 is formed of the same material as the holding member 32 in the first embodiment, and the thickness dimension and the width dimension are also formed to be the same. Although the wiring of the piezoelectric element 33 in the first embodiment is omitted, a wiring 233a is shown in the piezoelectric element 233 in this embodiment.

The wiring 233a is for transmitting a signal (voltage) generated in the piezoelectric element 233 due to the vibration of the striking surface 102a to the output device 205, and its width (lateral direction) dimension is formed to be substantially the same as the lateral direction of the piezoelectric element 233, and the wiring 233a is connected to the lower end of the piezoelectric element 233.

A portion of the wiring 233a is disposed between the sensor attachment part 222 and the double-sided tape 231. That is, the double-sided tape 231 adheres (fixes) the holding member 232 and the wiring 233a to the sensor attachment part 222.

Further, since the dimension of the piezoelectric element 233 (wiring 233a) in the lateral direction (arrow L-R direction) is formed smaller than the width dimension (dimension in the arrow L-R direction) of the double-sided tape 231, the double-sided tape 231 can fix the holding member 232 and the wiring 233a to the sensor attachment part 222.

The output device 205 includes a terminal 205a and a substrate 205b. The terminal 205a is disposed in the shell 2101 in a state where a portion of the terminal 205a penetrates the shell 2101 and an external device (not shown) can be connected to the terminal 205a. The signal generated in the piezoelectric element 233 is output to the outside via the wiring 233a, the substrate 205b, and the terminal 205a.

The detection device 201 is fixed to the drum 200 in a state where a portion of the holding member 232 is in contact with an inner surface 102b, which is a surface of the head 102 on a side opposite to the striking surface 102a (the arrow D direction side). As a result, the hitting area of the striking surface 102a can be increased. Further, it is possible to prevent the detection device 201 from being damaged by being hit by a stick or the like (not shown).

Further, by fixing the detection device 201 to the shell 2101, the detection device 201 can be fixed to the drum 200 regardless of the shape of the hoop 103.

Next, a detection device 301 according to a third embodiment will be described with reference to (a) of FIG. 6. Further, the same parts as those in the embodiments described above are denoted by the same reference numerals, and the description thereof will be omitted.

In FIG. 6, (a) is a partially enlarged cross-sectional view of the detection device 301 and a drum 300 according to the third embodiment, and corresponds to the cross section taken along the line IIa-IIa of FIG. 1.

As shown in (a) of FIG. 6, the detection device 301 according to the third embodiment includes an attachment member 302, a striking surface sensor 303 attached to the attachment member 302, and the output device 205 disposed on the lower side (arrow D direction) of the attachment member 302. The detection device 301 is fixed to the drum 300 by tightening with a bolt (not shown) or adhering the attachment member 302 to the inner peripheral surface of the shell 2101.

The attachment member 302 includes a fixing part 321 made of a resin material or a metal material and extending along the axis O1 direction of the shell 2101 (arrow U-D direction) (see FIG. 1) and a sensor attachment part 322 extending from the upper end of the fixing part 321 substantially parallel to the striking surface 102a in the stationary state toward the central side of the shell 2101 (arrow F direction side), and is formed in an L shape in a cross-sectional view. The fixing part 321 is fixed to the inner peripheral surface of the shell 2101, and the striking surface sensor 303 is attached to the upper surface of the sensor attachment part 322.

The striking surface sensor 303 includes a holding member 332 and a piezoelectric element 333 held (attached) to the holding member 332, and the holding member 332 is adhered to the sensor attachment part 322 via double-sided tapes 331. A pair of double-sided tapes 331 are disposed on the upper surface of the sensor attachment part 322, and two ends of the holding member 332 are adhered to the upper surfaces of the double-sided tapes 331.

The holding member 332 is formed of the same material as the holding member 32 in the first embodiment, and the thickness dimension and the width dimension are also formed to be the same. Further, since the piezoelectric element 333 is formed the same as the piezoelectric element 233 according to the second embodiment except that the size and length of a wiring 333a are different, the description thereof will be omitted.

The holding member 332 is formed in a rectangular sheet shape in a plan view, and is disposed with its longitudinal direction along the front-back direction of the detection device 301 (arrow F-B direction). A pair of flat adhesive parts 332a are formed at two ends of the holding member 332 in the front-back direction along the shape of the double-sided tapes 331. The portion connecting the pair of adhesive parts 332a is formed to be curved in an arc shape that protrudes toward the inner surface 102b.

Since the portion of the holding member 332 excluding the adhesive parts 332a is formed curved in an arc shape, in the embodiment, the holding member 332 in the state before the detection device 301 is fixed to the drum 300 is described as a semicircular shape.

A portion of the wiring 333a is disposed between the sensor attachment part 322 and the pair of double-sided tapes 331. Further, since the dimension of the piezoelectric element 333 (wiring 333a) in the lateral direction (arrow L-R direction) is formed smaller than the width dimension (dimension in the arrow L-R direction) of the double-sided tapes 331, the double-sided tapes 331 can fix the holding member 332 and the wiring 333a to the sensor attachment part 322.

In the stationary state, a portion of the holding member 332 comes into contact with the inner surface 102b, whereby the portion excluding the adhesive parts 332a is deformed. In the deformed portion of the holding member 332, the portion formed flat along the inner surface 102b is defined as a contact part 332b. The contact part 332b is formed on the upper side of the holding member 332 (arrow U direction side).

Further, among portions connecting the adhesive parts 332a and the contact part 332b of the holding member 332, the portion on the front side (arrow F direction side) is defined as a front part 332c, and the portion on the back side (arrow B direction side) is defined as a back part 332d, respectively. The front part 332c is a portion where the piezoelectric element 333 is attached to its outer peripheral surface.

The curvature of the holding member 332 (front part 332c) excluding the adhesive parts 332a changes according to the vibration of the striking surface 102a due to the impact, and the piezoelectric element 333 expands and contracts, so that the vibration of the striking surface 102a can be detected.

Next, a detection device 401 according to a fourth embodiment will be described with reference to (b) of FIG. 6. Further, the same parts as those in the embodiments described above are denoted by the same reference numerals, and the description thereof will be omitted.

In FIG. 6, (b) is a partially enlarged cross-sectional view of the detection device 401 and a drum 400 according to the fourth embodiment, and corresponds to the cross section taken along the line IIa-IIa of FIG. 1.

As shown in (b) of FIG. 6, the detection device 401 according to the fourth embodiment includes an attachment member 402, a striking surface sensor 403 attached to the attachment member 402, and the output device 205 disposed on the lower side (arrow D direction) of the attachment member 402. The detection device 401 is fixed to the drum 400 by tightening with a bolt (not shown) or adhering the attachment member 402 to the inner peripheral surface of the shell 2101.

The attachment member 402 includes a fixing part 421 made of a resin material or a metal material and extending along the axis O1 direction of the shell 2101 (arrow U-D direction) (see FIG. 1), an intermediate part 422 extending from the upper end of the fixing part 421 toward the central side of the shell 2101 (arrow F direction side), and a sensor attachment part 423 extending to the upper side (arrow U direction) from an end of the intermediate part 422 on a side (arrow F direction side) opposite to the side to which the fixing part 421 is connected. The fixing part 421 is fixed to the inner peripheral surface of the shell 2101, and the striking surface sensor 403 is attached to the inner peripheral surface of the sensor attachment part 423.

The striking surface sensor 403 includes a holding member 432 and a piezoelectric element 433 held (attached) to the holding member 432, and the holding member 432 is adhered to the sensor attachment part 423 via a double-sided tape 431.

The holding member 432 is formed to be the same as the holding member 32 in the first embodiment except that the outer diameter of the holding member 432 is different from the outer diameter of the holding member 32. That is, the holding member 432 is formed of the same material as the holding member 32 in the first embodiment, and the thickness dimension and the width dimension are also formed to be the same. Since the piezoelectric element 433 is formed the same as the piezoelectric element 233 according to the second embodiment except that the size and length of a wiring 433a are different, the description thereof will be omitted.

A portion of the wiring 433a is disposed between the sensor attachment part 423 and the double-sided tape 431. Further, since the dimension of the piezoelectric element 433 (wiring 433a) in the lateral direction (arrow L-R direction) is formed smaller than the width dimension (dimension in the arrow L-R direction) of the double-sided tape 431, the double-sided tape 431 can fix the holding member 432 and the wiring 433a to the sensor attachment part 423.

The detection device 401 is fixed to the drum 400 in a state where a portion of the holding member 432 on the upper side (arrow U direction side) is in contact with the inner surface 102b. As a result, the hitting area of the striking surface 102a can be increased.

Further, it is possible to prevent the detection device 401 from being damaged by being hit by a stick or the like (not shown). Further, the position where the piezoelectric element 433 is attached to the holding member 432 is between the inner surface 102b and the double-sided tape 431.

Further, by fixing the detection device 401 to the shell 2101, the detection device 401 can be fixed to the drum 400 regardless of the shape of the hoop 103.

Although the disclosure has been described above based on the above embodiments, the disclosure is not limited to the above embodiments, and it can be easily inferred that various modifications and improvements can be made without departing from the spirit of the disclosure.

In each of the above embodiments, the case where the holding members 32, 232, 332 and 432 are formed of a polyethylene terephthalate (PET) film has been described, but the disclosure is not necessarily limited thereto, and the holding members 32, 232, 332 and 432 may be formed of a resin material such as polypropylene or cellophane or of a metal material having predetermined deformation characteristics.

In the first embodiment, the case where the piezoelectric element 33 is attached to the region including the front protrusion 32c2 of the front part 32c has been described, but the disclosure is not necessarily limited thereto, and the piezoelectric element 33 may be attached to a region that does not include the front protrusion 32c2. Further, the piezoelectric element 33 may be attached to the back part 32d.

In the first embodiment and the third embodiment, the piezoelectric elements 33 and 333 may be attached over the front parts 32c and 332c and the adhesive parts 32a and 332a (or the contact parts 32b and 332b). Further, the piezoelectric elements 33 and 333 may be attached to the entire circumference of the holding members 32 and 332.

In each of the above embodiments, the case where the piezoelectric elements 33, 233, 333 and 433 are attached to the outer peripheral side of the holding members 32, 232, 332 and 432 has been described, but the disclosure is not necessarily limited thereto, and the piezoelectric elements 33, 233, 333 and 433 may be attached to the inner peripheral side of the holding members 32, 232, 332 and 432.

In each of the above embodiments, the case where the entire surface of the piezoelectric elements 33, 233, 333 and 433 is adhered (attached) to the holding members 32, 232, 332 and 432 has been described, but the disclosure is not necessarily limited thereto, and the intermediate part may not be adhered as long as two ends of the piezoelectric elements 33, 233, 333 and 433 in the longitudinal direction may be adhered.

In the first embodiment and the third embodiment, the case where the holding members 32 and 332 are disposed in a posture in which the axis O2 is aligned with the left-right direction of the detection devices 1 and 301 (arrow L-R direction) has been described. As a result, it is possible to prevent the contact parts 32b and 332b of the holding members 32 and 332 from inclining with respect to the adhesive parts 32a and 332a due to the vibration (displacement) of the striking surface 102a, and the front parts 32c and 332c (back parts 32d and 332d) can be prevented from twisting. However, the holding members 32 and 332 may be disposed in a posture in which the axis O2 is inclined with respect to the left-right direction of the detection devices 1 and 301, or the axis O2 is aligned with the front-back direction of the detection devices 1 and 301 (arrow F-B direction).

In each of the above embodiments, the case where the thickness dimension and the width dimension (dimension in the axis O2 direction) of the holding members 32, 232, 332 and 432 are formed to be constant over the entire circumference has been described, but the disclosure is not necessarily limited thereto, and the thickness dimension and the width dimension (dimension in the axis O2 direction) of the holding members 32, 232, 332 and 432 may change in the circumferential direction.

In each of the above embodiments, the detection devices 1, 201, 301 and 401 may include a plurality of striking surface sensors 3, 203, 303 and 403. For example, the detection devices 1, 201, 301 and 401 may include two striking surface sensors 3, 203, 303 and 403, and the striking surface sensors 3, 203, 303 and 403 may be brought into contact with the striking surface 102a and the inner surface 102b. In this way, it is possible to easily maintain a state in which at least one of the striking surface sensors 3, 203, 303 and 403 is in contact with the striking surface 102a or the inner surface 102b. Further, by disposing the striking surface sensors 3, 203, 303 and 403 at positions overlapping the axis O1 direction of the shells 101 and 201 (arrow U-D direction), the striking surface 102a (inner surface 102b) can be clamped from two sides, and it is possible to more easily maintain the state in which the striking surface sensors 3, 203, 303 and 403 are in contact with the striking surface 102a (inner surface 102b).

Further, for example, a plurality of striking surface sensors 3, 203, 303 and 403 may be disposed along the circumferential direction or the radial direction of the striking surface 102a. In particular, by disposing a plurality of striking surface sensors 3, 203, 303 and 403 along the radial direction of the striking surface 102a, the vibration of the striking surface 102a including high frequencies to medium and low frequencies can be detected more faithfully.

Further, for example, one of the plurality of striking surface sensors 3, 203, 303 and 403 may be disposed at the central portion of the striking surface 102a. In this case, it is preferable that the outer diameters of the holding members 32, 232, 332 and 432 disposed in the central portion of the striking surface 102a are formed larger than the outer diameters of the holding members 32, 232, 332 and 432 disposed in the peripheral portion (other than the central portion) of the striking surface 102a. Further, it is preferable that the outer diameters of the holding members 32, 232, 332 and 432 are formed larger as they are disposed closer to the central portion of the striking surface 102a.

In each of the above embodiments, the detection devices 1, 201, 301 and 401 may be configured to provide a cushioning material between the holding members 32, 232, 332 and 432 and the striking surface 102a (inner surface 102b).

In the first embodiment, the case where the holding member 32 is attached to the sensor attachment part 22 by adhesion has been described, but the disclosure is not necessarily limited thereto, and the holding member 32 may be attached by screwing. In this case, since the holding member 32 is attached at a position for the contact part 32b to face the vibration direction of the striking surface 102a (axis O1 direction, arrow U-D direction), even if the attachment method is screwing, it is possible to prevent a shearing force from being generated at the screwed portion of the holding member 32 when the striking surface 102a vibrates, and it is possible to prevent cracks from being generated starting from the portion where the screw penetrates the holding member 32. Further, it is possible to prevent the holding member 32 from being worn at the portion where the screw penetrates due to the contact with the screw.

In the second to fourth embodiments, the attachment members 202, 302 and 402 of the detection devices 201, 301 and 401 may be displaceably attached in the axis O1 direction (arrow U-D direction) on the inner peripheral surface of the shell 2101. In this way, the amount of deformation of the holding members 32, 332 and 432 (piezoelectric elements 33, 333 and 433) in the stationary state can be adjusted.

In the second to fourth embodiments, the case where a portion of the wirings 233a, 333a and 433a is disposed between the sensor attachment parts 222, 322 and 423 and the double-sided tapes 231, 331 and 431 has been described, but the disclosure is not necessarily limited thereto, and a portion of the wirings 233a, 333a and 433a may be disposed between the holding members 232, 332 and 432 and the double-sided tapes 231, 331 and 431.

In each of the above embodiments, the case where the piezoelectric elements 33, 233, 333 and 433 are disposed in a posture with their longitudinal direction going along the circumferential direction of the holding members 32, 232, 332 and 432 has been described, but the disclosure is not necessarily limited thereto, and the piezoelectric elements 33, 233, 333 and 433 may be disposed in a posture with their longitudinal direction going along the width direction (axis O2 direction) of the holding members 32, 232, 332 and 432.

In each of the above embodiments, the case where the striking surface sensors 3, 203, 303 and 403 of the detection devices 1, 201, 301 and 401 are disposed in contact with the striking surface 102a of the drums 100, 200, 300 and 400 has been described, but the disclosure is not necessarily limited thereto, and the striking surface sensors 3, 203, 303 and 403 may be brought into contact with a vibrating portion of a musical instrument such as a guitar or a piano. Further, for example, the vibrating portion of the guitar includes strings and the body (front plate, back plate, side plate and the like), and the vibrating portion of the piano includes the strings, bridges, soundboard and body (side plates, roof, columns, frames and the like).

### DESCRIPTION OF REFERENCE NUMERALS

1, 201, 301, 401: Detection device
100, 200, 300, 400: Drum (musical instrument, percussion instrument)
102: Head (vibrating portion)
2: Main body member (holding part)
202, 302, 402: Attachment member (holding part)
32, 232, 332, 432: Holding member (base)
32a, 332a: Adhesive part (first part)
32b, 332b: Contact part (second part)
33, 233, 333, 433: Piezoelectric element (piezoelectric sensor)

1-9. (canceled)

10. A percussion instrument comprising:
a head;
a base that has at least a portion formed in a curved shape and that is in contact with the head in a direction in which a curvature of the curved shape is changed with a vibration of the head; and
a film-shaped piezoelectric sensor disposed on the base.

11. The percussion instrument according to claim 10, wherein the base is pressed against the head and is elastically deformed.

12. The percussion instrument according to claim 10, further comprising:
a holding part for holding the base,
wherein the base is formed in an annular shape.

13. The percussion instrument according to claim 12, wherein a first part of the base held by the holding part and a second part of the base in contact with the head face each other in a vibration direction of the head.

14. The percussion instrument according to claim 12, wherein the holding part is detachably attached to the head.

15. The percussion instrument according to claim 10, wherein the base is formed of a polyethylene terephthalate film.

16. The percussion instrument according to claim 10, wherein the piezoelectric sensor is disposed on a portion of an outer peripheral surface of the base in a circumferential direction.

17. The percussion instrument according to claim 16, wherein an upper end and a lower end of the piezoelectric sensor are disposed at a predetermined distance in an up-down direction from a lower end of the base, and the predetermined distance is set in a range of 1/20 to ⅕ of an outer diameter dimension of the base.

18. The percussion instrument according to claim 10, wherein the piezoelectric sensor is disposed over an entire circumference of an outer peripheral surface of the base.

19. The percussion instrument according to claim 10, wherein a thickness dimension of the base is 250 μm.

20. A detection device comprising:
a base that has at least a portion formed in a curved shape and that is in contact with a displacing portion of a musical instrument in a direction in which a curvature of the curved shape is changed with a displacement generated by performance of the musical instrument; and
a sensor disposed on the base to detect a change of the curvature.

21. The detection device according to claim 20, wherein in a state where the detection device is disposed on the musical instrument, the base is pressed against the displacing portion of the musical instrument and is elastically deformed.

22. The detection device according to claim 20, further comprising:
a holding part for holding the base,
wherein the base is formed in an annular shape.

23. The detection device according to claim 22, wherein in a state where the detection device is disposed on the musical instrument, a first part of the base held by the holding part and a second part of the base in contact with the displacing portion of the musical instrument face each other in a displacement direction of the displacing portion of the musical instrument.

24. The detection device according to claim 22, wherein the holding part is detachably attached to the musical instrument.

25. The detection device according to claim 20, wherein the musical instrument is configured by a percussion instrument, and the displacing portion of the musical instrument is a head of the percussion instrument.

26. A detection method comprising:
bringing a base that has at least a portion formed in a curved shape in contact with a vibrating portion of a musical instrument in a direction in which a curvature of the curved shape is changed with a vibration generated by performance of the musical instrument; and
detecting a vibration of the vibrating portion of the musical instrument by a film-shaped piezoelectric sensor disposed on a portion of the base where the curvature changes.

27. The detection method according to claim 26, wherein the musical instrument is configured by a percussion instrument, and the vibrating portion of the musical instrument is a head of the percussion instrument.

28. The detection method according to claim 26, wherein the base is brought into contact with the vibrating portion of the musical instrument in a state of being elastically deformed in advance to detect a change of the curvature by the vibrating portion of the musical instrument.
